(19) United States
(12) Patent Application Publication
(10) Pub. No.: US 2016/0330537 A1
(43) Pub. Date: Nov. 10, 2016

(54) HYBRID HEADSET TUNED FOR OPEN-BACK AND CLOSED-BACK OPERATION

(71) Applicants: Derek Boyd Barrentine, Gilroy, CA (US); Anand A. Parthasarath, Cupertino, CA (US)

(72) Inventors: Derek Boyd Barrentine, Gilroy, CA (US); Anand A. Parthasarath, Cupertino, CA (US)

(73) Assignee: AliphCom, San Francisco, CA (US)

(21) Appl. No.: 14/705,901

(22) Filed: May 6, 2015

(51) Int. Cl. H04R 1/10; H04R 1/28; G10K 11/178; H04R 1/32

(52) U.S. Cl. CPC H04R 1/1041; H04R 1/1008; H04R 1/32; H04R 1/1066; H04R 1/28; G10K 11/1782; H04R 2460/01; H04R 2201/103; H04R 2420/07; G10K 2210/1081

(57) ABSTRACT

A hybrid headphone includes a variable aperture device configured to reversibly switch the hybrid headphone between an open-back mode of operation and a closed-back mode of operation. Closed-back mode may be used to provide acoustic isolation from ambient noise to improve audio intelligibility of content due to a reduction and/or elimination of the ambient noise. The hybrid headphone may automatically be switched from the open-back mode to the closed-back mode when ANC is activated or in response to a signal or data. The hybrid headphone may include a semi-open-back mode that is between the open-back and closed-back modes. The variable aperture device may be commanded to an open position for the open-back mode, a closed position for the closed-back mode, and a partially open position for the semi-open mode. The variable aperture device may include a shutter, a hole, a port, or a port including a variable acoustic impedance material.

### FIELD

Embodiments of the present application relate generally to electrical and electronic hardware, computer software, wired and wireless communications, Bluetooth systems, RF systems, low power RF systems, near field RF systems, portable personal wireless devices, signal processing, audio transducers, and consumer electronic (CE) devices.

### BACKGROUND

Over-ear and on-ear headphones may come in different configurations, with typical configurations including an open-back design or a closed-back design (also referred to a sealed or sealed-back design). Less prevalent are semi-open headphones which provide a compromise between open-back and closed-back designs. In the open-back design, drivers of the headphones are not in a sealed chamber and are acoustically coupled with an environment external to the headphones so that sound being generated by the drivers (e.g., a moving coil transducer) radiates into the ears of the user and also radiates into the environment external to the headphones. For example, the driver radiates acoustic energy into the user's ear and also radiates acoustic energy into the external environment. Furthermore, ambient sound in the environment external to the headphones may be heard by the user of the open-back design headphones. Some users may perceive the open-back design provides the best audio quality and/or a sense of spaciousness to the sound. Some users may prefer the open-back design because it allows for ambient sounds to be heard and/or does not be acoustically isolate the user from ambient noise in the environment.

On the other hand, in the closed-back design, drivers of the headphones are in a sealed or closed chamber and are acoustically isolated from the environment external to the headphones. For example, both sides of a diaphragm of the driver are sealed off from the external environment. Closed-back headphones offer the user a higher degree of privacy than open-back designs and may also offer a higher level of acoustic isolation from ambient noise. Typically, the acoustic isolation provided by closed-back designs typically may not provide total acoustic isolation as external ambient noise may still be perceived by the user, albeit at a reduced sound level than would be case for an open-back design.

Closed-back designs are also typically used in over-ear or on-ear headphones that employ systems for active noise cancellation (ANC). In an ANC mode, the closed-back design may offer an even higher level of acoustic isolation from ambient noise (e.g., cabin noise from aircraft, etc.). However, there may be some applications where a user may want the benefits of a closed-back design and there may be other applications where the user may want the benefits of an open-back design.

Accordingly, there is a need for systems, apparatus and methods for implementing open back and closed back designs in the same over-ear or on-ear headphones.

### BRIEF DESCRIPTION OF THE DRAWINGS

Various embodiments or examples (“examples”) are disclosed in the following detailed description and the accompanying drawings:

FIG. 1 depicts one example of a flow for a hybrid headphone;

FIG. 2 depicts another example of a flow for a hybrid headphone;

FIG. 3 depicts yet another example of a flow for a hybrid headphone;

FIG. 4 depicts one example of a block diagram for a hybrid headphone;

FIG. 5 depicts one example of a hybrid headphone and examples of external devices that may be in wired and/or wireless communication with the hybrid headphone;

FIG. 6 depicts an exploded profile view of examples of components in a channel of a hybrid headphone and examples of hard-wired hybrid headphone controls;

FIG. 7 depicts one example of a number of shutters that may be included in a hybrid headphone;

FIG. 8 depicts examples of iris-based shutters in various positions from an open position through a closed position;

FIG. 9 depicts examples of ports that may be included in a hybrid headphone; and

FIG. 10 depicts front, profile and cross-sectional views of ports that may be included in a hybrid headphone.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, a method, an apparatus, a user interface, or a series of executable program instructions included on a non-transitory computer readable medium. Such as a non-transitory computer readable medium or a computer network where the program instructions are sent over optical, electronic, or wireless communication links and stored or otherwise fixed in a non-transitory computer readable medium. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

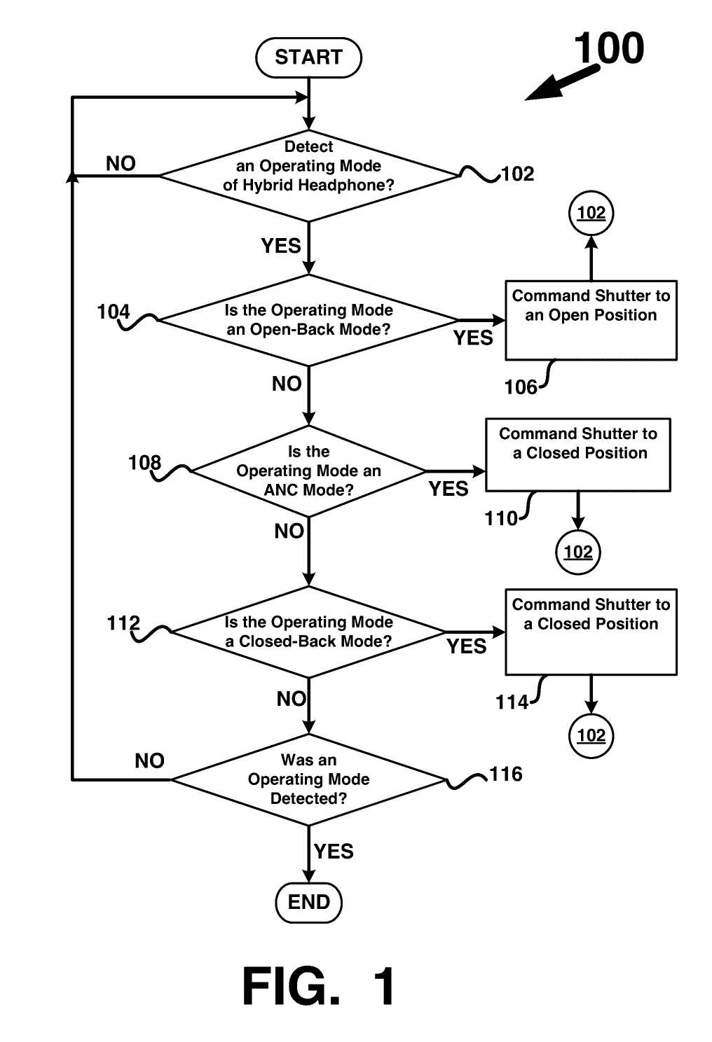

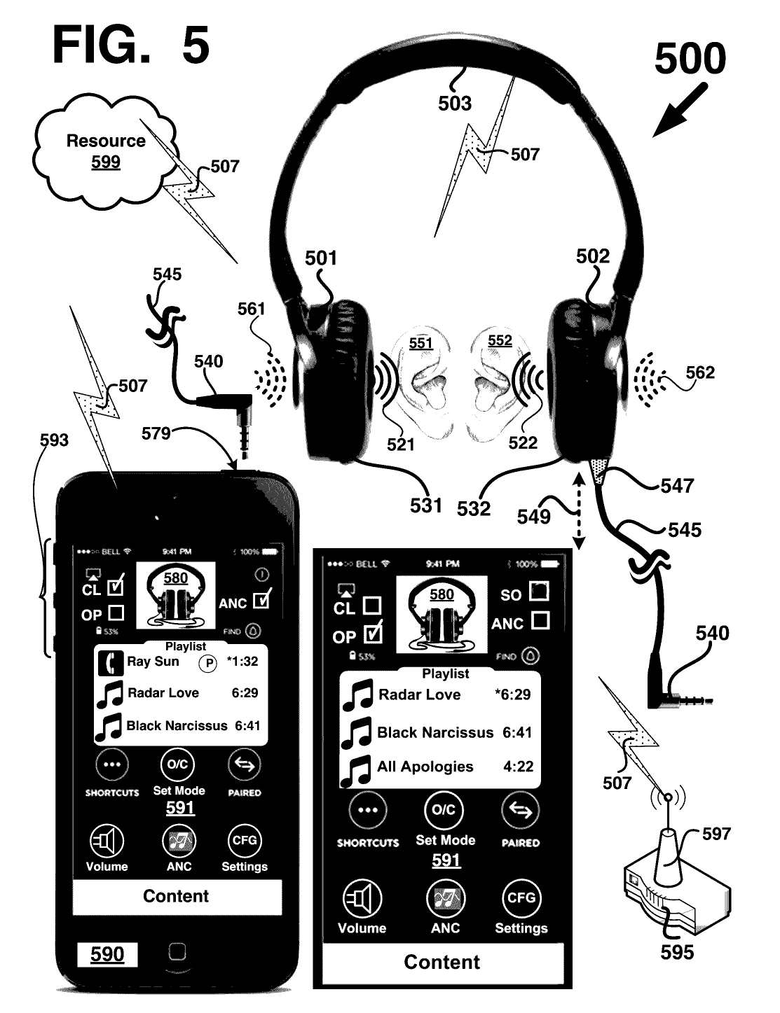

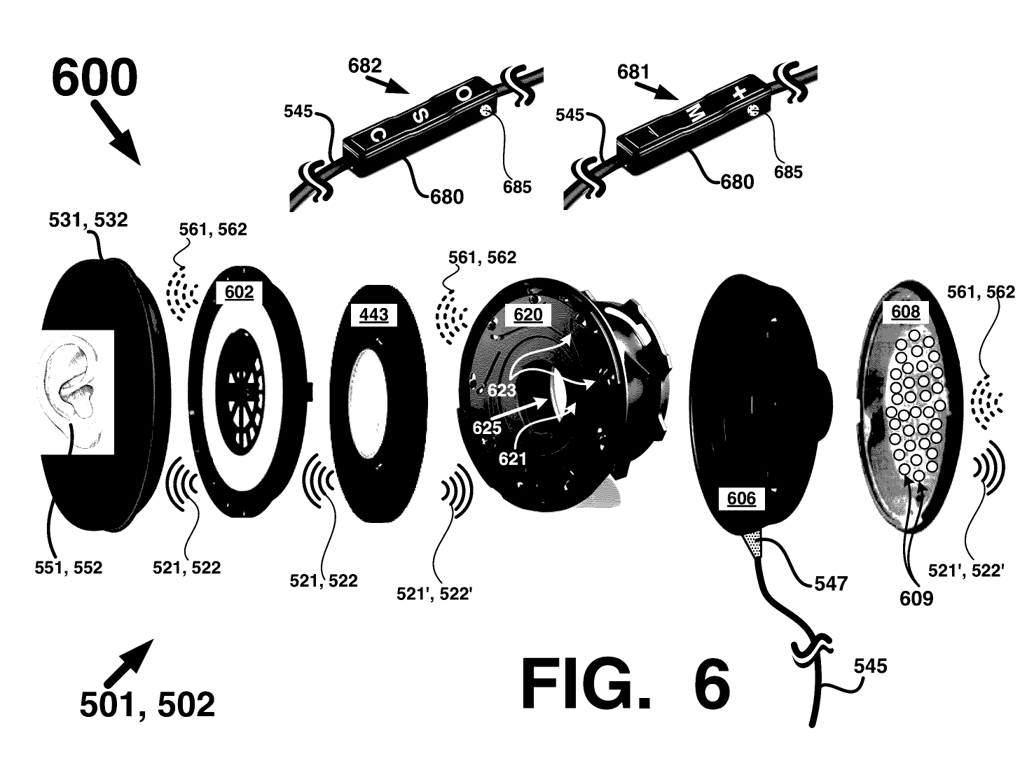

Attention is now directed to FIG. 1 where one example of a flow 100 for a hybrid headphone 500 (see FIGS. 5 and 6) is depicted. Flow 100 may be implemented using circuitry and/or one or more non-transitory computer readable mediums including program instructions and/or data operative to execute on one or more compute engines (e.g., a processor, controller, μP, μC, DSP, FPGA, ASIC, etc.). Examples of non-transitory computer readable mediums includes but is not limited to electronic memory, RAM, DRAM, ROM, EEPROM, Flash memory, and non-volatile memory, for example. The one or more non-transitory computer readable mediums may be distributed over a number of devices as will be described below (e.g., plural wireless headsets and/or a wireless client device).

At a stage 102 a decision may be made to detect one of a number of different operating modes of a hybrid headphone. If a NO branch is taken from the stage 102, then flow 100 may transition to another stage such as back to stage 102 where flow 100 may continually test whether or not to detect the operating mode. If a YES branch is taken from the stage 102, then flow 100 may transition to another stage such as a stage 104 where a determination may be made as to whether or not the operating mode is an open-back mode. At the stage 104, if a YES branch is taken, then flow 100 may transition to a stage 106 where a command or other signal may be executed to cause a shutter to be set to an open position as will be described in greater detail below. After the command to set the shutter to the open position has been executed, the flow 100 may transition from the stage 106 to another stage, such as back to the stage 102, for example.

If a NO branch is taken from the stage 104, then flow 100 may transition to another stage, such as a stage 108. At the stage 108 a determination may be made as to whether or not the operating mode is an active noise cancellation (ANC) mode. If a YES branch is taken from the stage 108, then flow 100 may transition to a stage 110 where the shutter may be commanded to a closed position. After the command to set the shutter to the closed position has been executed, the flow 100 may transition from the stage 110 to another stage, such as back to the stage 102, for example.

If a NO branch is taken from the stage 108, then flow 100 may transition to another stage, such as a stage 112. At the stage 112 a determination may be made as to whether or not the operating mode is a closed-back mode. If a YES branch is taken from the stage 112, then flow 100 may transition to a stage 114 where the shutter may be commanded to a closed position. After the command to set the shutter to the closed position has been executed, the flow 100 may transition from the stage 114 to another stage, such as back to the stage 102, for example. A signal applied to a motor, linear motor, servo, actuator, piezoelectric device or other device coupled to the shutter may be operative to command the shutter to open, closed or intermediate positions.

If a NO branch is taken from the stage 112, then flow 100 may transition to another stage, such as a stage 116 where a determination may be made as to whether or not an operating mode was detected during execution of flow 100. If a YES branch is taken, then flow 100 may terminate. If a NO branch is taken, then flow 100 may transition to another stage, such as back to the stage 102, for example.

Data representing content (e.g., phone conversations, music, audio, or other) being played back on the hybrid headphone may be communicated to the hybrid headphone using a hard-wired connection, such as a headphone cable or USB cable, which may include a microphone and headphone controls, and/or by a wireless communications link between the hybrid headset and an external wireless device and/or network, such as a smartphone, cellular phone, tablet, pad, PC, server, laptop computer, wireless router, WiFi router, gaming device, an external resource such as the Cloud and/or the Internet, for example. The wireless communications link may comprise one or more wireless protocols including but not limited to one or more varieties of IEEE 802.x, Bluetooth (BT), BT Low Energy (BTLE), WiFi, WiMAX, Cellular, Software-Defined-Radio (SDR), HackRF, and Near Field Communication (NFC), AdHoc WiFi, short range RF communication, long range RF communication, just to name a few. One or more radios in the hybrid headphone may be used for wireless communications with other wireless devices.

The setting of operating modes and execution of commands may be accomplished using signals or data communicated to the hybrid headset via a communications link that may be a wired link, a wireless link of both. Similarly, an external device may determine a status of the hybrid headphone (e.g., current operating mode: open; closed; intermediate, status of a power supply, active noise cancellation enabled/disabled, volume levels, equalization, balance, wireless network connections, etc.) via the wired link, wireless link or both. The external device may detect operating modes of the hybrid headphone and may command positions of the shutter via data and/or signals communicated via the communications link. In other examples, circuitry included in the hybrid headphone (e.g., in an ear cup and/or a head band) may generate and/or receive signals and/or data to detect the operating mode and/or command positions of the shutter.

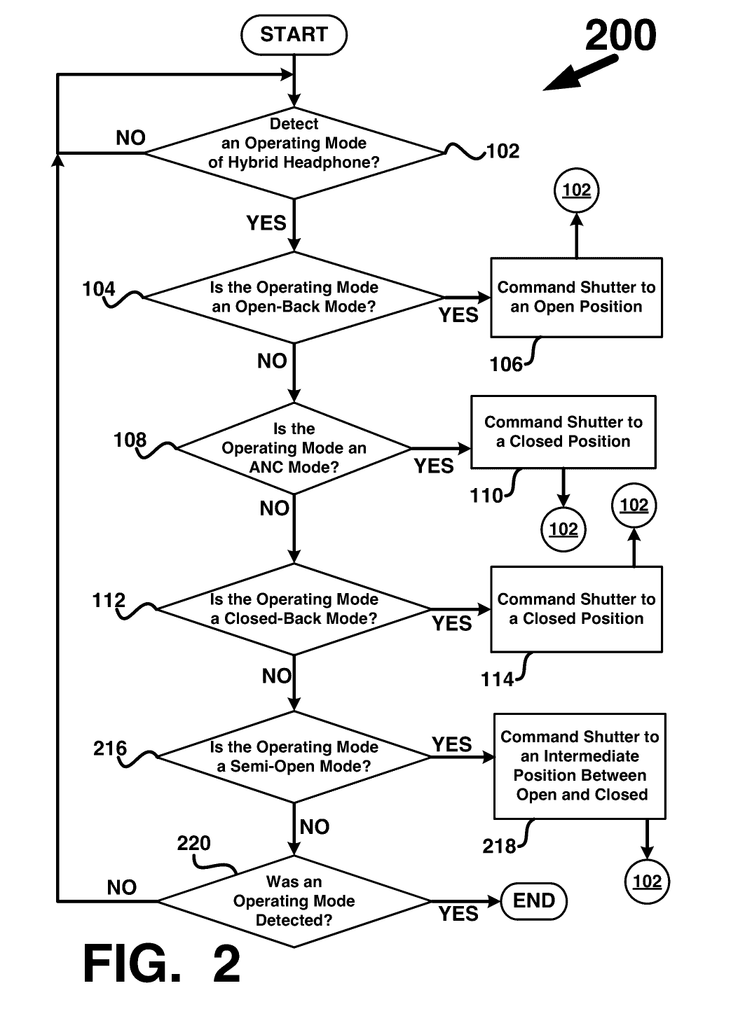

Turning now to FIG. 2 where another example of a flow 200 for a hybrid headphone is depicted. Here, in flow 200, at a stage 216 a determination may be made as to whether or not a semi-open mode operating mode was detected. If a YES branch is taken from the stage 216, then flow 200 may transition to another stage, such as the stage 218 where the shutter may be commanded to an intermediate position (e.g., a position that is somewhere between a fully open position of the shutter and a fully closed position of the shutter). After the command to set the shutter to the intermediate position has been executed, the flow 200 may transition from the stage 218 to another stage, such as back to the stage 102, for example.

If a NO branch is taken from the stage 216, then flow 200 may transition to another stage, such as a stage 220 where a determination may be made as to whether an operating mode has been detected during execution of flow 200. If a YES branch is taken, then flow 200 may terminate. If a NO branch is taken, then flow 200 may transition to another stage, such as back to the stage 102, for example.

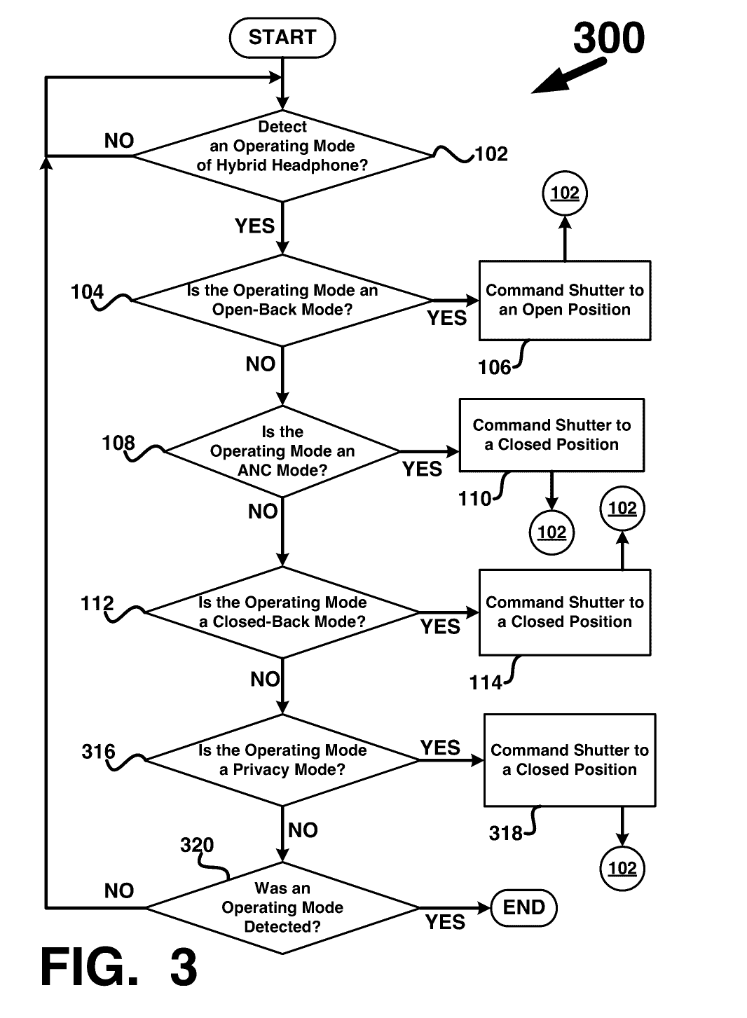

Moving on to FIG. 3 where yet another example of a flow 300 for a hybrid headphone is depicted. Here, in flow 300, at a stage 316 a determination may be made as to whether or not a privacy operating mode has been detected (e.g., a mode where sound being played back by the hybrid headphone may not be overheard by persons in close proximity of the hybrid headphone). If a YES branch is taken from the stage 316, then flow 300 may transition to a stage 318 where the shutter may be commanded to a closed position. After the command to set the shutter to the closed position has been executed, the flow 300 may transition from the stage 318 to another stage, such as back to the stage 102, for example.

If a NO branch is taken from the stage 316, then flow 300 may transition to another stage, such as a stage 320 where a determination may be made as to whether an operating mode was detected during execution of flow 300. If a YES branch is taken, then flow 300 may terminate. If a NO branch is taken, then flow 300 may transition to another stage, such as back to the stage 102, for example. In some examples, the privacy mode set at the stage 318 may be identical to the closed-back mode set at the stage 114, the ANC mode set at the stage 110 or both. Data representing content being served or otherwise being handled by the hybrid headphone may be used to set the privacy mode. For example, if a smartphone in wireless communication with the hybrid headphone receives an incoming phone call or VoIP call, and the caller is identified by a portion of the data representing the content (e.g., data representing a contact from a contacts list) as a caller whose phone calls are to be handled confidentially (e.g., made private) when the hybrid headphone is donned, then receiving that phone call may automatically cause the hybrid headphone to execute the stage 318 (e.g., via hardware, software or both) and the shutter may be commanded to close so that sound from the conversation may not be audible in the ambient environment external to the hybrid headphone or is attenuated to a level making the sound difficult to hear by a third party in close proximity of the hybrid headphone (e.g., by a passenger in an adjacent seat in an airplane). Although flows 100-300 describe a shutter, other types of variable apertures may be used, such as one or more ports as will be described below and the present application is not limited to the shutter configuration. The variable aperture may be a component or structure that may be commanded (e.g., in response to a signal applied to the variable aperture) to an open position, a partially open position, or a closed position, for example. In that a partially open position may be indistinguishable from a partially closed position, the term partially open will be used hereinafter to describe different degrees of being open that are less than fully opened but not completely closed. In some examples, the variable aperture may have two states (e.g. like a SPST switch), an open state (e.g., fully open) and a closed state (full closed), with no intermediate states (e.g., a partially open state). A digital signal, such as a binary “1” may be applied to the variable aperture to switch it to the open state and binary “0” may be applied to the variable aperture to switch it to the closed state, for example. A multi-bit digital signal may be applied to a variable aperture device having intermediate states (e.g., partially open) between the open and closed states. For example, a two-bit digital signal applied to the variable aperture device may have states: 00; 01; 10; and 11. Variable aperture device may be closed (e.g., fully closed) for state 00, have a first partially open setting for state 01 and a second partially open setting for state 10, and be open (e.g., fully open) for state 11.

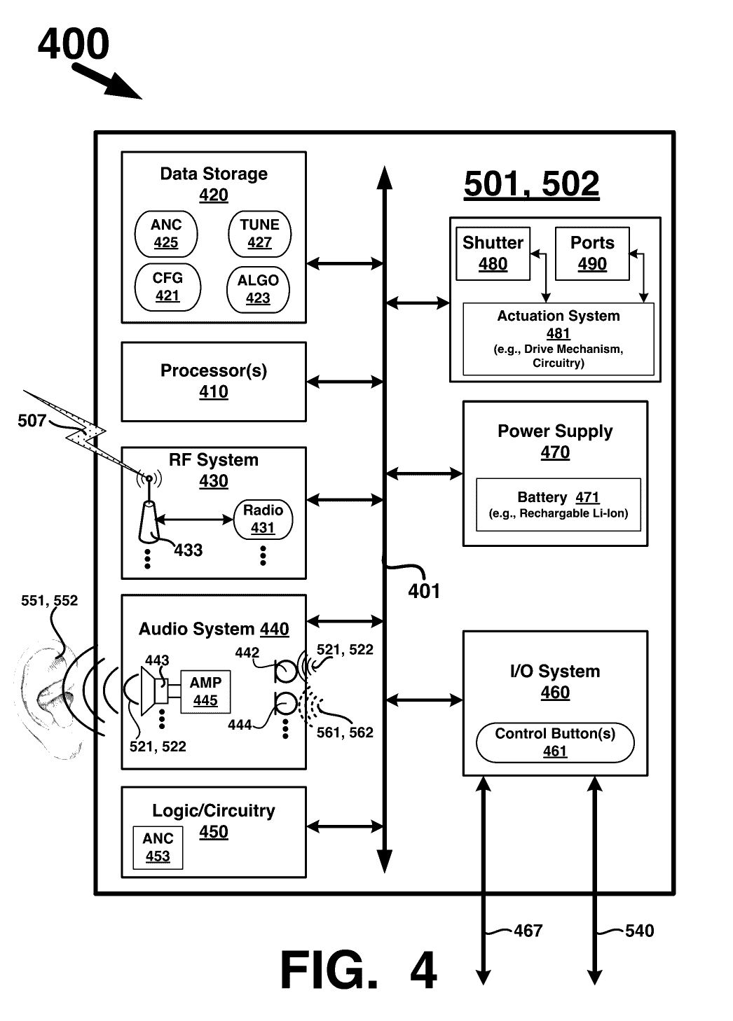

Reference is now made to FIG. 4 where one example of a block diagram 400 for a hybrid headphone is depicted. Systems and components of the hybrid headphone may be electrically coupled with each other using a bus 401 or other electrically conductive structure for electrically communicating signals. Hybrid headphone may have systems including but not limited to: a processor(s) 410; data storage 420; a RF system 430; an audio system 440; logic/circuitry (e.g., analog and/or digital) 450; an I/O system 460; a power supply 470, a shutter 480 and/or ports 490.

Processor(s) 410 may comprise one or more compute engines and the processor(s) 410 may execute algorithms and/or data embodied in a non-transitory computer readable medium (e.g., included in data storage 420), such as algorithms (ALGO) 423, configuration file (CFG) 421, active noise cancellation (ANC) algorithms denoted as ANC 425, and audio tuning algorithms TUNE 427 (e.g., equalization, tuning for different operating modes such as open-back, closed-back, ANC, semi-open). Processor(s) 410 may include but are not limited to one or more of a processor, a controller, a μP, a μC, a DSP, a FPGA, and an ASIC, for example. Data storage 420 may comprise one or more types of electronic memory such as Flash memory, non-volatile memory, RAM, ROM, DRAM, and SRAM, for example. Configuration (CFG) 421 may include data including but not limited to access credentials for access to a network such as a WiFi network or Bluetooth network, MAC addresses, Bluetooth addresses, data used for configuring the hybrid headphone to automatically recognize and/or link with other wireless devises, to determine a type of radio and/or a wireless protocol (e.g., BT, BTLE, NFC, WiFi, etc.) to use for one or more wireless links, for example.

RF system 430 may include one or more antennas 433 coupled with one or more radios 431. Wireless links between the hybrid headphone and other wireless devices may be handled by the same or different radios 431. Different radios 431 may be coupled with different antennas 433 (e.g., one antenna for NFC and another antenna for WiFi).

I/O system 460 may include a communication port 467 for a wired connection with an external device such as an Ethernet network, USB port, a charging device for charging a rechargeable battery in power supply 470, for example. As one example, communication port 467 may comprise a micro or mini USB port for wired communication between the hybrid headphone and an external device and/or between the hybrid headphone and an external charging device, such as a charger the hybrid headphone docks with or an AC or DC charger. I/O system 460 may also include a hardwired connection 540 that may be removable from the hybrid headphone (e.g., a captive or removable headphone cable with or without microphone and/or audio or other controls). For example, a DIN, mini-DIN, USB, micro USB, mini USB, TRS, TRRS, 3.5 mm plug, ¼ inch plug or the like, may be removeably coupled with the hybrid headphone.

Power supply 470 may source one or more voltages for systems in the hybrid headphone and may include a rechargeable power source denoted as battery 471, such as a Lithium Ion type of battery, for example. Battery 471 may be recharged by an external source via communication port 467 and/or wireless charging, for example.

Audio system 440 may include a number of transducers and their associated amplifiers, preamplifiers, and other circuitry. The transducers may include one or more speakers 443 which may be coupled with one or more amplifiers 445 which drive signals to speaker 443 to generate sound 521, 522 that is acoustically coupled into ears (551, 552) of a user (not shown). Multiple speakers 443 may be used, to reproduce different frequency ranges (e.g., bass, midrange, treble), for example, and those multiple speakers 443 may be coupled with the same or different amplifiers 445 (e.g., bi-amplification, tri-amplification).

The transducers may also include one or more microphones 442, 444 or other types of transducer that may convert mechanical energy (e.g., vibrations, sound waves from ambient sound and/or speech) into an electrical signal. Examples of microphones that may be used includes but is not limited to MEMS microphones, matched MEMS microphones (e.g., microphone die from the same semiconductor substrate), accelerometers, MEMS accelerometers, matched MEMS accelerometers (e.g., accelerometer die from the same semiconductor substrate), electro-condenser microphones (ECM), just to name a few. An accelerometer used as both a microphone and an accelerometer may be operative to generate signals indicative of incident sound and/or motion signals indicative of motion (e.g., of the hybrid headset). A number of the microphones 442, 444 may be configured into a microphone array or other configurations. The transducers may include accelerometers, piezoelectric devices, or other type of transducer operative to generate a signal from motion, pressure changes, mechanical energy, etc. Microphones 442, 444 or other type of transducers may be coupled with appropriate circuitry (not shown) such as preamplifiers, analog-to-digital-converters (ADC), digital-to-analog-converters (DAC), DSP's, analog and/or digital circuitry, for example. The appropriate circuitry may be included in audio system 440 and/or other systems such as logic/circuitry 450 (e.g., circuitry for active noise cancellation ANC 453). Processor(s) 410 may execute one or more algorithms (e.g., CFG 421, ANC 425, TUNE 427, ALGO 423) separately or in conjunction with hardware, circuitry, or logic such as in logic/circuitry 450 and/or audio system 430, for example. Transducer 442 (e.g., one or more microphones) may be operative to receive sound (521, 522) generated by speaker 443 and transducer 444 (e.g., one or more microphones) may be operative to receive sound (561, 562) generated by ambient sound in an environment around the hybrid headphone. Signals from transducers 442 and/or 444 may be used for active noise cancellation (ANC), such as the ANC modes described above in regards to flows 100-300 in FIG. 1-3. In the ANC mode, sound (521, 522) generated by speaker 443 may include the sound from content being played back on the hybrid headphone and sound operative to negate or attenuate ambient noise (e.g., an out of phase ambient noise signal or anti-noise signal). Signals from transducers 442 and 444 may be processed by circuitry and/or algorithms to implement the ANC mode.

Shutter 480 may include an actuation system operative to open the shutter, close the shutter or actuate the shutter to an intermediate position that is between open and closed, as was described above in regards to flows 100-300 in FIG. 1-3. Shutter 480 may include various structures operative to reversibly convert the hybrid headset from open-back mode to closed-back mode or vice-versa. Shutter 480 may also reversibly convert the hybrid headset from the open-back mode to a semi-open mode or from the closed-back mode to the semi-open mode. Shutter 480 may also reversibly convert the hybrid headset from the open-back mode to the ANC mode or from the semi-open mode to the ANC mode.

Non-limiting examples of structures that may be used to implement shutter 480 include a shutter (e.g., similar to a camera shutter), a valve, vanes (e.g., rotary or articulated), louvers, blinds, an iris, a smart rubber, a memory muscle material (e.g., artificial muscle that changes stiffness and/or shape as a function of an applied signal such as current or voltage), and a piezoelectric material, just to name a few. Shutter 480 is operative to acoustically seal an acoustic chamber or volume the speaker 443 is disposed in from an ambient environment external to the hybrid headset when the shutter 480 is closed, or to allow acoustic coupling of the speaker 443 with the ambient environment external to the hybrid headset (e.g., in the Semi-Open operating mode). Shutter 480 when open may form an aperture or hole through which acoustic energy may pass. An amount of the acoustic energy that may pass through the aperture formed by opening shutter 480 may depend on a size of the aperture. The size of the aperture may be commanded from a fully open position where the aperture has its maximum size, to a partially open position, where the aperture may have a size that is less than its maximum size when fully open. The aperture may be negated by closing shutter 480. For purposes of explanation, an iris will be depicted as one non-limiting example of a structure for shutter 480. Actuation system 481 may comprise a drive mechanism and/or circuitry operative to actuate the shutter 480 to its open, closed, or optionally intermediate positions. For an iris used as the shutter 480, the actuation system may comprise rotary or linear motors and associated gears, linkages, cams, and the like. An iris for a camera lens (e.g., a digital camera or video device) or other optical device may be adapted for user as the shutter 480, for example. One or more apertures or holes 490 may be included in hybrid headphone and those apertures or holes 490 (ports 490 hereinafter) may be actuated by actuation system 481. Each port 490 may be actuated to an open position, a closed position, or optionally to intermediate positions. Ports 490 may be used in addition to or instead of shutter 480. In some examples, ports 490 and shutter 480 may be implemented using identical or similar mechanisms (e.g., an iris for ports 490 and for shutter 480). In other examples, ports 490 and shutter 480 may be implemented using different mechanisms (e.g., an iris for shutter 480 and a memory material or artificial muscle material for ports 490). Actual mechanisms for shutter 480, ports 490, and actuation system 481 may be application dependent. Ports 490 and shutter 480 may be positioned at different locations on the hybrid headphone. In some applications, hybrid headphone may include more than one shutter 480 and/or more than one port 490.

Hybrid headphone may include at least one ear cup (e.g., a single ear cup, a right ear cup, a left ear cup or right and left ear cups) and one or more systems depicted in block diagram 400 of FIG. 4 may be included (e.g., duplicated) in an ear cup, such as audio system 440, shutter 480 and actuation system 481, power supply 470 and/or battery 471, processor(s) 410, or other systems. An ear cup may include a single shutter 480 or multiple shutters 480 and associated actuation system 481 (e.g., a single actuation system 481 may actuate multiple shutters 480 or each shutter 480 may have its own dedicated actuation system 481). An ear cup may include a single port 490 or multiple ports 490 and associated actuation system 481 (e.g., a single actuation system 481 may actuate multiple ports 490 or each port 490 may have its own dedicated actuation system 481). One or more systems depicted in block diagram 400 of FIG. 4 may be included in other portions of the hybrid headphone, such as in a headband, and/or in a boom coupled with an ear cup, for example

Now description turns to FIG. 5 where one example of a hybrid headphone 500 and examples of external devices (590, 595, 599) that may be in wired and/or wireless communication with the hybrid headphone 500 are depicted. Hybrid headphone 500 may be an over-ear headphone having a head band 503 or other structure coupled with a right ear cup 501 and a left ear cup 502. Hybrid headphone 500 may have a single ear cup and is not limited to the right 501 and left 502 ear cup configuration depicted in FIG. 5. As will be described in greater detail in FIG. 6, each ear cup (501, 502) may include one or more transducers, shutters, ports, and other components or systems, such as those depicted in FIG. 4. In some examples, hybrid headphone 500 may be an on-ear headphone. Each ear cup (501, 502) may include an associated ear pad (531, 532). One or both of the ear cups (501, 502) may include a communication port (e.g., a USB port) for a wired connection that may be captive or removable. Here, left ear cup 502 includes a connector 547 operative to removeably couple 549 a headphone cable 545 with the hybrid headphone 500 (e.g., with port 540 of I/O system 460). Headphone cable 545 may be coupled with an appropriate connecter 540 for electrically coupling signals between the hybrid headphone 500 and an external device, such as a client device 590 that may also be a wireless device. Connector 540 may be a DIN, mini-DIN, USB, micro USB, mini USB, TRS, TRRS, 3.5 mm plug, ¼ inch plug or the like, for example. Connector 540 may be inserted or removed from a female connector 579 on client device 590, for example.

Right ear cup 501 and left ear cup 502 may be operative to couple sound (521, 522) with right 551 and left 552 ears. Right ear cup 501 and left ear cup 502 may also include a structure such as an end cap, a screen, or a baffle through which ambient sound (561, 562) may enter into the hybrid headphone 500 (e.g., when shutter 480 is open-back mode or semi-open mode). Right ear cup 501 and left ear cup 502 may be mounted with head band 503 using structures that allow for articulation and/or adjustment of the ear cups (501, 502) along one or more axes.

Hybrid headphone 500 may be wirelessly linked with one or more external wireless devices including but not limited to a smartphone (e.g., client device 590), a wireless network, a WiFi network, a wireless router (e.g., 595), a Bluetooth network, a Bluetooth Low Energy network, an external resource 599 (e.g., the Cloud, Cloud storage, the Internet, NAS, RAID, server(s), a wearable electronic device, a wireless speaker box, etc.).

In the open-back mode or semi-open mode, sound (521, 522) and ambient sound (561, 562) may be audibly detected by ears (551, 552). Moreover, in the open-back mode or semi-open mode, sound (521, 522) may be heard by persons in the external environment as sound leakage from the hybrid headphone 500 (e.g., from vents, ports in an end cap). A volume of the sound leakage may depend in part on a volume setting for the drivers in the right and left ear cups (501, 502).

An external device (e.g., smartphone 590), such as a wireless client device or other, may control one or more functions of the hybrid headphone 500, such as setting an operational mode to open-back, closed-back, or semi-open, for example. In some examples, the external device may be hard wired, wireless, or both. As one example, client device 590 may wirelessly 507 communicate with hybrid headphone 500 and may execute and application (APP) 580 configured to present information (e.g., icons) on a display 591 (e.g., a touch screen display) of the device 590. Activation of icons or the like on display 591 may be used to control operation, make settings (e.g., stored on the device 590 and/or in data storage 420), activate modes (e.g., via Set Mode O/C icon), change volume (e.g., via a Volume icon or using hard controls 593), display wireless linkage status (e.g., via a PAIRED icon), activate/deactivate the ANC mode (e.g., via an ANC icon), show current ANC status (e.g., via an ANC icon with checkbox □), show current mode status (e.g., via CL (closed) and OP (open) icons and their checkboxes □), show remaining charge in battery 471 (e.g., via a battery icon), allow a user to modify settings of the hybrid headphone 500 (e.g., via Settings (CFG) icon), and content being served to the hybrid headphone 500 (e.g., a playlist), for example. A graphical user interface (GUI) for APP 580 may include different icons, different features, different menu selections, and may have a different appearance than depicted in the example of FIG. 5.

Settings may be used to determine how content being presented by the client device affects the hybrid headphone 500. For example, in a playlist of content, a phone call from “Ray Sun” may be at the top of a content queue (e.g., it is the content currently being played back) and ahead of other content that may be played in a queuing order, such as music “Radar Love” followed by music “Black Narcissus”. Data representing a tag may designate content (e.g. phone calls) from “Ray Sun” as private “P” (e.g., in a data field for “Ray Sun” in a contacts list on client device 590). The data representing the tag may be generated by one or more of logic, hardware, or software. In some examples, the data representing the tag may be included in data representing the content. As one example, the tag may be a field in a data packet that includes the content as a data payload. Here, upon receiving the phone call from “Ray Sun”, the client device 590 may wirelessly transmit 507 data packets to hybrid headphone 500 that include a field that includes a privacy flag that when decoded by the processor 410, initiates a command to close the shutter 480, thereby automatically setting the mode to the closed-back mode. In the closed-back mode, sound leakage may be eliminated or attenuated making it impossible or harder for other persons to overhear the phone conversation. APP 580 causes the display of the status of hybrid headphone 500 by indicating that the content from from “Ray Sun” is private (e.g., the encircled “P” presented on display 591) and is actively being played back as denoted by an asterisk “*” that precedes a talk time (e.g., *1:32), the mode is closed-back (e.g., by the check mark in the box next to the CL icon), and that ANC is activated (e.g., by a check mark in the box next to the ANC icon).

After the phone call to “Ray Sun” is terminated, the content for the phone call may be flushed from the playlist and the next item of content may move to the top of the queue and go active, as in the case of “Radar Love” with an “*” next to its playing time. Here, APP 580 may cause the hybrid headphone 500 to switch from the closed-back mode to the open-back mode (e.g., based on stored data representing settings or preferences for listening to music) as indicated by the check mark in the box next to the OP icon. In the open-back mode, ANC may be deactivated as indicated by no check mark in the box next to the ANC icon. In some examples, hybrid headphone 500 may be configured to automatically command setting an operating mode based on a learned behavior of a user or in response to a trigger (e.g., a trigger included in data transmitted by client device 590). As one example, if an airplane mode is activated in client device 590, APP 580 may communicate data representing an activation of the Airplane Mode to hybrid headphone 500 via a wired or wireless link. A processor in hybrid headphone 500 may decode the data representing the activation of the airplane mode and cause activation of an operating mode based on the decoded data (e.g., command the closed-back mode).

The ANC icon with the music symbol in it may be used by a user to activate/deactivate the ANC mode, where activating the ANC mode sets the shutter 480 to the closed position and deactivation the ANC mode sets the shutter to the open-back mode, for example. Although not depicted in FIG. 5, APP 580 may present another mode icon associated with a semi-open mode, such as a SO icon with a check box next to it.

Now referring to FIG. 6 where an exploded profile view 600 of examples of components in a channel (e.g., a single ear cup, a left ear cup 502 or a right ear cup 501) of a hybrid headphone 500 and examples of hard wired hybrid headphone controls (681, 682) are depicted. In exploded profile view 600, a channel (501, 502) of the hybrid headphone 500 may include an ear pad (531, 532) which may be configured for over-ear mounting or configured for on-ear mounting. Ear pad (531, 532) is operative to acoustically couple sound (521, 522) generated by driver 433 with an ear (551, 552) (e.g., the pinna and other structure surrounding the entrance to the ear cannal). The ear pad (531, 532) may also be operative, in conjunction with head band 503, to facilitate mounting of the hybrid headphone 500 on a head of the user with the ear pads (531, 532) in contact with and acoustically aligned with the ears (551, 552).

A channel (501, 502) of the hybrid headphone 500 may also include a plate 602 (e.g., a dispersion plate or driver plate) positioned between the ear pad (531, 532) and the driver 443. Furthermore, a channel (501, 502) may include an acoustic chamber 606 and an end cap 608 (e.g., a housing). End cap 608 may include a number of fixed apertures 609 (e.g., through holes, openings, a mesh, a screen, louvers, or the like) through which ambient sound (561, 562) may enter the hybrid headphone 600 and through which sound (521′, 522′) generated by driver 443 may exit into the ambient environment. Headphone cable 547 may connect 547 with acoustic chamber 606 or some other component of a channel (501, 502).

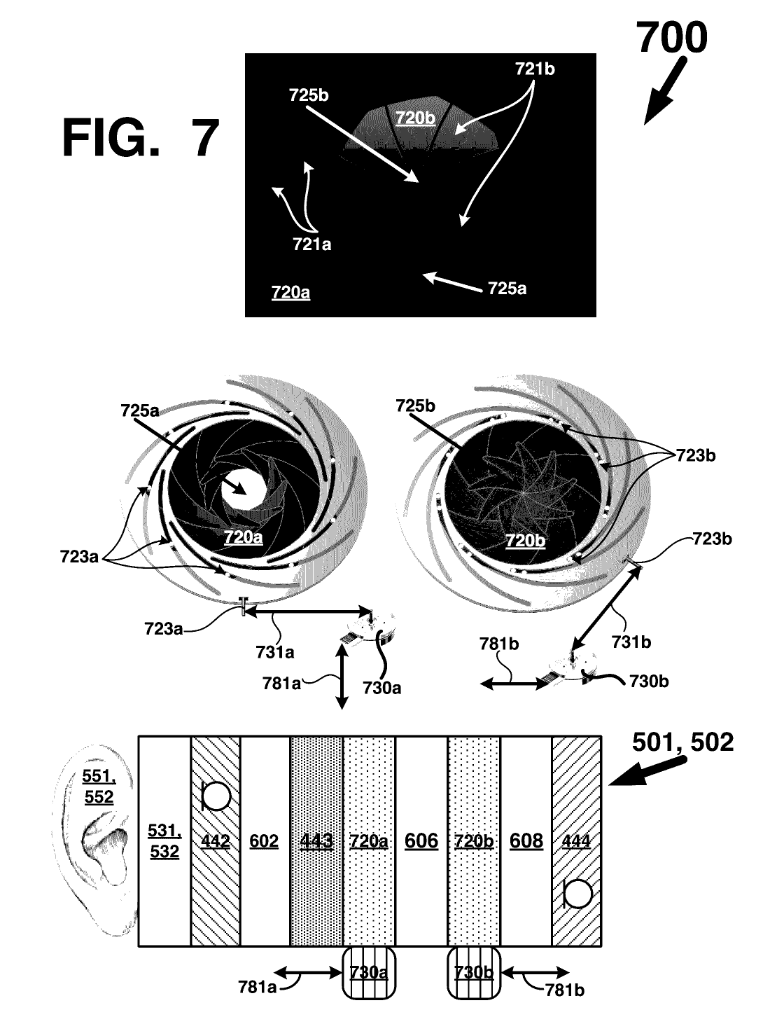

A shutter 620 may be positioned in a channel (e.g., 501, 502 or both) at a suitable location between the driver 443 and end cap 608, such as between the driver 443 and acoustic chamber 606, for example. Shutter 620 may comprise an iris mechanism (iris hereinafter) that includes a number of movable blades 621 coupled with a mechanism 623 configured to cause the blades 621 to expand outward to enlarge an opening 625 (e.g., a diameter of opening 625) of the shutter 620 or contract inward to reduce or close the opening 625. Shutter 620 may be fully open when opening 625 is expanded outward to its maximum diameter and may be fully closed when opening 625 is contracted to close the opening 625 (e.g., the diameter is zero). Signals applied to mechanism 623 may move blades 621 from a fully open position (e.g., maximum diameter) to a fully closed position (e.g., zero diameter) or an intermediate position (e.g., diameter less than maximum but greater than zero) such that blades 621 may be operative as a variable diameter aperture or hole, for example. The closed-back operating mode may constitute blades 621 being fully closed (e.g., zero diameter), the open-back operating mode may constitute blades 621 being fully open (e.g., maximum diameter), and the semi-open operating mode may constitute blades 621 being opened to an intermediate diameter between maximum diameter and zero diameter, for example. As one example, the fully open position may have a maximum diameter of 25 mm, the semi-open position may have a diameter of 10 mm, and the fully closed position a diameter of 0 mm. Operation of the iris will be described in greater detail below in regards to FIG. 7. In some examples, the shutter 620 may be a separate component of a channel (501, 502) as depicted in FIG. 6. In other examples, the shutter 620 may be integrated with one or more components of a channel (501, 502), such as the acoustic chamber 606 that includes the shutter 620, for example. In other examples, a position of the shutter 620 in a channel (501, 502) may be different than depicted in FIG. 6, such as a shutter disposed between the acoustic chamber 606 and the end cap 608. Actual placement, configuration, size, shape, and operation of the shutter 620 may be application dependent and is not limited to the examples described and/or depicted herein.

Headphone cable 545 (a captive or removable cable) may optionally include a control 680 (e.g., an inline control) configured to control functions of the hybrid headphone, such as volume (UP, DOWN, Mute), Shutter Mode (Open-back, Closed-Back, Semi-open, etc.). In example 681, control includes a button for volume up (+), volume down (−) and Mute Volume (M). In example 682, control 680 includes buttons for setting a mode of the shutter for Open-back (O), Closed-back (C), and optionally Semi-open (S). In some examples, control 680 may have the buttons depicted in examples 681 and 682 positioned on opposite sides or on the some side of the control 680. Control 680 may optionally include at least one microphone 685 for use during phone calls, etc. During a phone call, actuating the button “M” may be operative to mute signals caused by voice/speech/ambient sound incident on a microphone of the hybrid headphone 500. Operating modes of hybrid headphone 500 may be automatic; however, optional control 680 may be operative as a manual override and/or back-up control for setting the operating modes.

Shutter 620, when fully or partially open (depicted as partially open), may allow ambient sound (561, 562) to enter into the channel (501, 502) and be aurally detected by one or both ears (551, 552). Similarly, shutter 620 when fully or partially open (depicted as partially open in FIG. 6), may allow sound generated by driver 443 to exit from end cap 608 via openings 609 and be aurally perceived by others in the ambient environment (e.g., persons in near or close proximity of a user of the hybrid headphone 500). Sound generated by driver and exiting a channel (501, 502) through the end cap 608 is denoted as (521′ and 522′); whereas, sound generated by driver and exiting a channel (501, 502) through the ear pads (531, 532) is denoted as (521 and 522). Fully closing shutter 620 may eliminate or attenuate entering ambient sounds (561, 562) and may eliminate or attenuate exiting sounds (521′ and 522′).

Mechanism 623 may be coupled with a servo, motor, linear motor, piezoelectric device, or some other form of mechanical actuator. Coupling may be by gears, levers, cords, filaments, cams, springs, linkages, and the like. In other examples, a channel (501, 502) may include a number of shutters 620 (see example 700 in FIG. 7). A number of the shutters 620 may provide additional reductions in sound levels (e.g., in dB's) of ambient sound (561, 562) that enters hybrid headphone 500 and may also further reduce sound levels (e.g., in dB's) of sound (521′ and 522′) that exits hybrid headphone 500.

FIG. 7 depicts one example of a number of shutters (720a and 720b) that may be included in a channel (501, 502) of the hybrid headphone 500. Here, shutter 720a is depicted partially open with blades/leafs 721a of the iris forming an opening 725a (e.g., an intermediate diameter); whereas, shutter 720b is depicted fully closed with blades/leafs 721b of the iris not forming an opening 725a (e.g., a zero diameter). Shutters 720a and 720b may be positioned in a channel (501, 502) in a variety of positions, such as next to each other, separated from each other by another structure/component of a channel, etc. In FIG. 7, shutter 720a is depicted as being positioned in front of shutter 720b, however, the configuration depicted is a non-limiting example.

Mechanisms 723a and 723b of shutters 720a and 720b respectively, may be coupled 731a and 731b with an actuator 730a and 730b, with each actuator coupled 781a and 781b with actuation system 481 (see FIG. 4). Actuation system 481 may generate signals that open (e.g., open-back mode), close (e.g., closed-back mode), or command an intermediate position (e.g., semi-open mode) of blades 721a and 721b. Actuator 730a and 730b may include but are not limited to micro motors, solenoids, linear motors, or other form of actuator and may be selected based on size, torque, speed, power consumption, etc.

An example configuration for one or more shutters (720a, 720b) in a channel (501, 502) may be ordered from left to right as follows: ear pad (531, 532); plate 602; driver 443; shutter 720a; acoustic chamber 606; shutter 720b; and end cap 608. In open-back mode, both shutters (720a, 720b) may both be fully open or one or both may be partially open. In closed-back mode, both shutters (720a, 720b) may both be fully closed or one of the shutters may be partially open and the other shutter fully closed. For example, shutter 720b may be fully closed and shutter 720a may be partially open.

Optionally, another example configuration for one or more shutters (720a, 720b) in a channel (501, 502) may be ordered from left to right as follows: ear pad (531, 532); microphone 442 (e.g., for use with ANC); plate 602, driver 443; shutter 720a; acoustic chamber 606; shutter 720b; end cap 608; and microphone 444 (e.g., for use with ANC). Microphones 442 and 444 may capture generated sound from driver 443 and ambient sound (561, 562) respectively, and may generate signals that are coupled with ANC 453 of FIG. 4. Signals generated by ambient sound (561, 562) via microphone 444, may be used for generating anti-noise or some form of inverted sound waveform for ANC. ANC may use signals generated by microphone 442 for making real time adjustments and/or equalization during ANC processing. Microphone 442 may be positioned in or near ear cup (531, 532) to measure sound (521, 522) that enters the users ears (551, 552) to determine if the ambient sound (561, 562) has been effectively cancelled and/or reduced in volume (e.g., in dB's or as a measure of S/N).

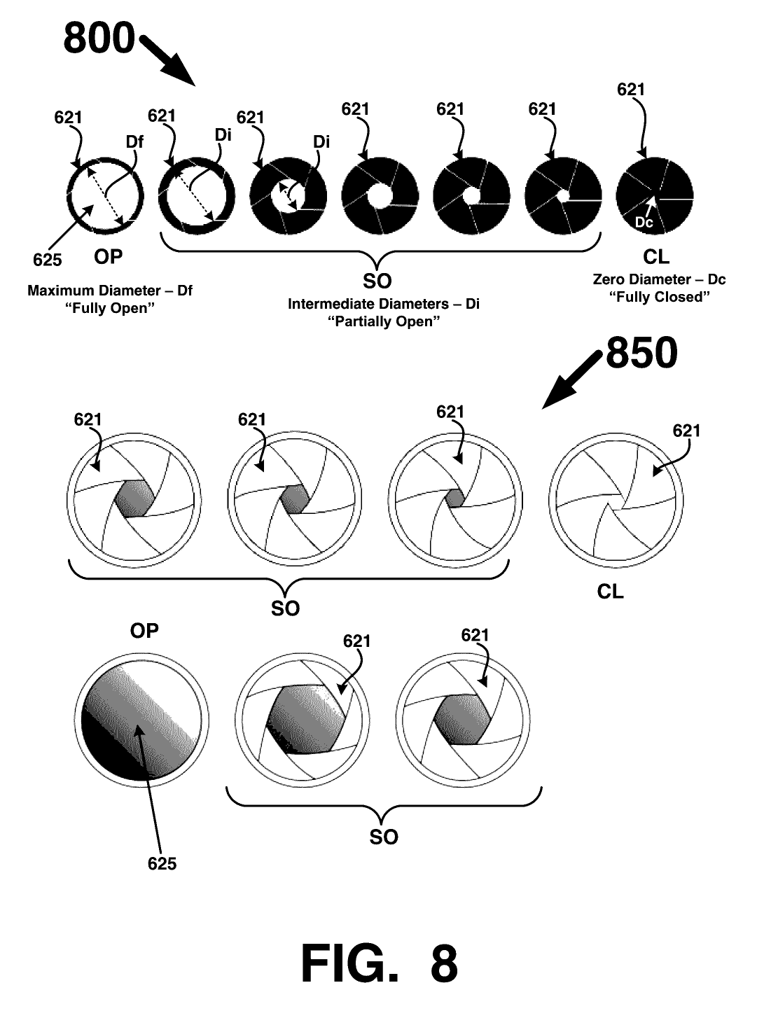

Turning now to FIG. 8 where examples of iris based shutters in various positions from fully open through fully closed are depicted. In example 800, from left to right on the drawing sheet, iris blades 621 are in a fully open position “OP” on the far left (e.g., where opening 625 is at its maximum diameter Df) and gradually move through various degrees of partially open positions “SO” (e.g., where opening 625 is depicted at various intermediate diameters Di), to a fully closed position “CL” on the far right (e.g., where opening 625 has a zero diameter Dc). Similarly, in example 850, in a fully open position “OP” iris blades 621 may be fully retracted and may not be visible, but gradually become visible in the partially open positions “SO”, and finally fully closing in a fully closed position “CL”. Examples 800 and 850 depict a variable aperture implemented using shutter 620; however, other variable aperture configurations may be used, such as ports 490, for example. A multi-bit digital signal (e.g., 3-bits) applied to shutter (480, 620) may actuate blades of the shutter (e.g., 621) to the different positions (e.g., as depicted in example 800 and 850) for example. A variable aperture device, such as shutter (480, 620) or port 490 may be coupled with a signal or signals that control open, closed, and partially open positions.

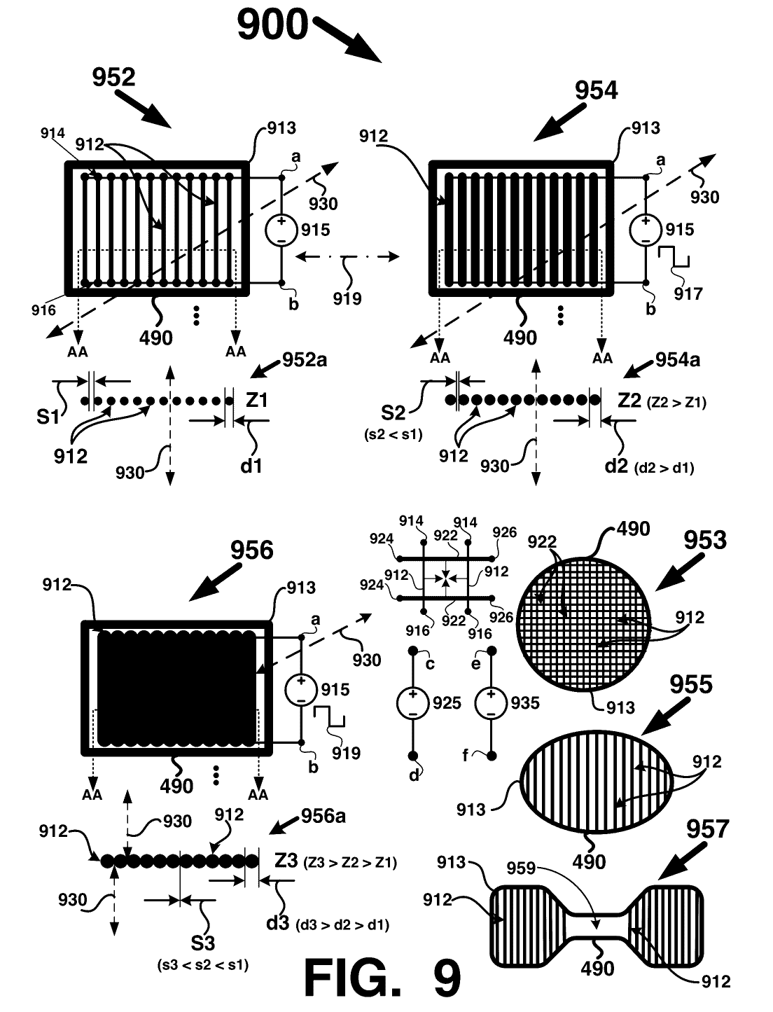

Moving on to FIG. 9 where examples 952-957 of ports 490 that may be included in a hybrid headphone are depicted. In example 952, a port 490 may include a frame, chassis or structure denoted as 913 and port 490 may include members 912 having nodes 914 and 916 that may be electrically coupled with nodes a and b, respectively, of a signal source 915. For example, signal source 915 may be included in actuation system 481 of FIG. 4. In example 952, members 912 may be in a fully open position (e.g., no signal, voltage, current, etc. applied to the members 912) and port 490 may have a first impedance Z1 to sound 930 incident on members 912. Sound 930 may pass through port 490 (e.g., pass between its members 912). Members 912 may be spaced apart by a distance S1 and each member 912 may have a dimension d1 (e.g., an approximate diameter). Distance S1 and/or dimension d1 may be approximate distances and dimensions due to slight variations in dimensions that may exist among the members 912. A cross-sectional view 952a along a dashed line AA-AA depicts sound 930 passing through members 912 having the dimension d1 and spacing S1. In example 952, first impedance Z1 may represent an acoustic impedance of port 490 to sound 930 (e.g., incident sound) when members 912 are spaced apart by distance of S1.

In example 954, signal source 915 is depicted applying a signal 917 to members 912 (e.g., to nodes 914, 916) and applied signal 917 is operative to cause a change in a shape of members 912 (e.g., an increase in dimension) such that the distance between members 912 decreases from spacing S1 to spacing S2 due to dimension d1 increasing to dimension d2 (e.g., an approximate increase in diameter of members 912). In cross-sectional view 954a in example 954, port 490 may have a second impedance Z2 that may represent an acoustic impedance of port 490 to sound 930 when members 912 are spaced apart by the distance of S2. The second impedance Z2 may represent an increased attenuation of sound 930 incident on port 490 (e.g., sound 930 passes through port 490 at a reduce intensity in dB's).

In example 956, signal source 915 is depicted applying a signal 919 to members 912 (e.g., to nodes 914, 916) and applied signal 919 is operative to cause a change in a shape of members 912. Applied signal 919 may be operative to cause adjacent members 912 to contact one another such that port 490 may have a third impedance Z3. As shown in cross-sectional view 956a, members 912 may be spaced apart by a distance S3 (e.g., distance S3≈0) and have a dimension d3 when signal 919 is applied. Sound 930 may be attenuated to a greater extent when port 490 has third impedance Z3, as compared to impedances Z2 or Z1 as described above. Therefore, in examples 952-956, impedance of port 490 may increase from Z1 to Z2 to Z3 as the dimensions of members 912 increase from d1 to d2 to d3 and spacing between members 912 decreases from S1 to S2 to S3.

In examples 953-957, port 490 may have shapes other than the shape (e.g., a rectangular shape) depicted in examples 952-956. Port 490 may have a circular shape as depicted in example 953, an arcuate (e.g., oval shape) as depicted in example 955, or a complex shape (e.g. a bow tie) as depicted in example 957. Actual shapes for port 490 may be application dependent and are not limited to the examples depicted herein. In example 957, port 490 may include a portion 959 that does not include members 912. In example 953, port 490 may include members 922 that are arranged in a different orientation relative to members 912 (e.g., orthogonally or some other angle or orientation). Signal source 925 may include nodes C and d that are electrically coupled with nodes 914 and 916, respectively, of members 912. Signal source 935 may include nodes e and f that are electrically coupled with nodes 924 and 926, respectively, of members 922. Signal sources 925 and 935 may be controlled (e.g., by an external signal) to apply signals to their respective members 912 and 922 in concert with each other or separately from each other to change the impedance (e.g., an acoustic impedance) of port 490. For example, when signal sources 925 and 935 both apply signals to their respective members 912 and 922, the members (912, 922) may move in a direction indicated by the inward pointing arrows to cause a constriction operative to increase the impedance of port 490. Members (912, 922) may also move in a direction opposite to that of the arrows to decrease the constriction thereby reducing the impedance of port 490.

In examples 952-957, ports 490 may be configured to be normally open, that is, without an applied signal, members (421, 422) may have an initial spacing (e.g., spacing S1) between them based on some initial dimension (e.g., such as d1) and those spacing's and dimensions may change with an applied signal is applied (e.g., dimension increases and spacing decreases). On the other hand, ports 490 may be configured to be normally closed, that is, without an applied signal, members (421, 422) may have an initial spacing (e.g., spacing S3) between them based on some initial dimension (e.g., such as d3) and those spacing's and dimensions may change as signal is applied (e.g., dimension decreases and spacing increases). Port 490 may be operative to perform similarly to shutter 480 and may be used as an alternative structure to shutter 480. Shutter 480 and/or port 490 may be positioned in a hybrid headphone (e.g., hybrid headphone 500) relative to a transducer such as one or more speakers (e.g., 443), microphones (e.g., 442, 444), accelerometers, or motion sensors, for example. Shutter 480 and/or port 490 may be used to alter a frequency response (e.g., a low frequency response) in a hybrid headphone. Shutter 480 and/or port 490 may be used to attenuate sound generated by a transducer and/or incident on a transducer (e.g., speaker, microphone, accelerometer, motion sensor). For example, a microphone in an active noise cancellation (ANC) system may include a shutter 480 or port 490 that may be positioned to attenuate and/or block ambient sound that is incident on the microphone (e.g., when hybrid headphone 500 is in an ANC mode).

Suitable materials for port 490 (e.g., for members 912, 922) may include but are not limited to a smart rubber, a memory muscle material (e.g., artificial muscle that changes stiffness and/or shape as a function of an applied signal such as a current or a voltage), and a piezoelectric material, and a MEMS device, just to name a few. Members 912 and/or 922 may form a variable acoustic impedance material, a variable acoustic impedance cloth, a variable acoustic impedance screen, or a variable acoustic impedance grill, that may be positioned relative to a transducer and/or a path were sound may enter and/or exit hybrid headphone 500. The ports 490 and/or shutters 480 may be used in one or more channels (e.g., right, left, mono, stereo) of other devices including but not limited to on-ear headphones, over-ear headphones, in-ear phones, custom ear molds, ear buds, in-canal earphones, intra-concha earphones, and other types of wearable devices and earpieces that may be used to couple sound into an ear. In some examples, materials for members (912, 922) may be selected to be tuned to a frequency or frequency range to be attenuated by port 490).

In examples 952-957, one or more of the ports 490 may be configured to be tuned to one or more different frequencies or frequency ranges operative to attenuate ambient noise having frequency content in the one or more different frequencies or frequency ranges. For example, spacing of members (912, 922) may be modulated to attenuate the frequency content in the one or more different frequencies or frequency ranges. Materials selected for members (912, 922) may be selected to match an acoustic impedance operative to attenuate the frequency content in the one or more different frequencies or frequency ranges solely or in combination with modulating the spacing of members (912, 922). For example, a frequency range from about 30 Hz to about 100 Hz may be selected to attenuate low frequency ambient noise. As another example, a frequency range from about 1,000 Hz to about 1,500 Hz may be selected to attenuate low frequency ambient noise associated with traffic noise (e.g., from cars and other vehicles). Actuation system 481 may apply signals to members (912, 922) to modulate their spacing from open to closed, or spacing's between open and closed. Signals from one or more microphones positioned to receive ambient noise may be analyzed (e.g., using a DSP) to determine frequency content of the ambient noise and signals may be generated based on the analysis to command actuation system 481 to change spacing's in members (912, 922).

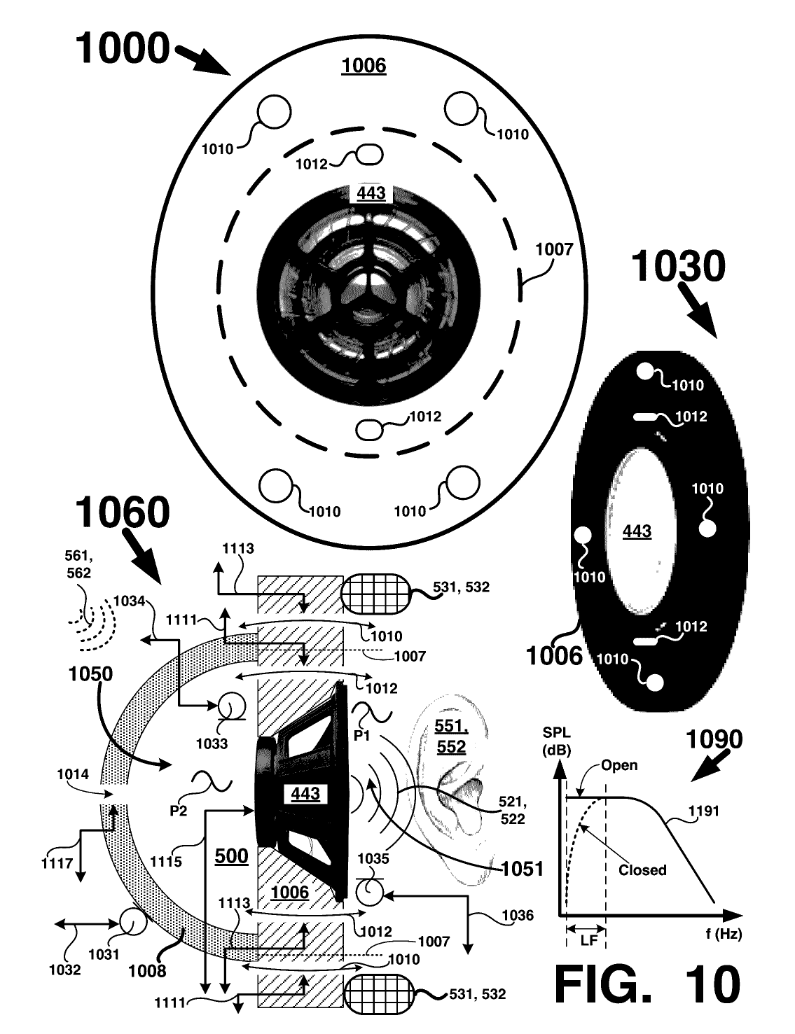

Reference is now made to FIG. 10 where front, profile and cross-sectional views of ports 1010, 1012, and 1014 that may be included in a hybrid headphone (e.g., hybrid headphone 500) are depicted. Ports 1010, 1012, and 1014 may be positioned on one or more structures of the hybrid headphone. In example 1000, ports 1010 and 1012 may be positioned at different locations on a mounting plate 1006 (e.g., a speaker baffle plate) in which speaker 443 is mounted or otherwise connected with. The number, position, size and shapes of ports 1010 and 1012 may be application dependent and are not limited by the configurations depicted in example 1000. In example 1000, dashed line 1007 denotes an outline of an acoustic chamber (not shown, but see 1008 of example 1060 and 606 of FIG. 6) positioned behind speaker 443. Ports 1012 are positioned on mounting plate 1006 so that they are inside a perimeter of the dashed line 1007 and are operative as portal between a first volume (e.g., 1050 in example 1060) of the acoustic chamber and a second volume between the mounting plate 1006 and pinna of the user when hybrid headphone is mounted on the head of the user. Ports 1010 are positioned outside of the perimeter of the dashed line 1007 and are operative as a portal between the second volume and an environment external to the hybrid headphone (e.g., an environment the user is in). The port 490 depicted in FIG. 9 and/or the shutter apparatus 480, 620, 720a, or 720b of FIGS. 4, 6, 7 and 8 may be used to implements ports 1010 and/or 1012.

Example 1030 depicts a profile view of mounting plate 1006 having ports 1010 and 1012 positioned on the mounting plate 1006; however, a different positioning for ports 1010 and a different shape for ports 1012 are depicted in example 1030. Through holes or apertures may be formed in mounting plate 1006 and ports (1010, 1012) may be fabricated in those apertures or may be positioned in those apertures (e.g., added to the plate 1006 as a separate component). Sound 521, 522 generated by speaker 443 and/or air flow generated by motion of speaker 443 may pass through ports 1010, 1012. Ambient sound 561, 562 may pass through one or more of the ports, such as ports 1010, for example. Sound 521, 522 generated by speaker 443 and/or air flow generated by motion of speaker 443 may be attenuated by opening, closing, or partially opening/closing of one or more of the ports 1010 and/or 1012. Air flow may be generated by speaker 443 displacing air in chamber 1008 and/or acoustic volume 1051 due to motion of a cone or other structure of speaker 443 that moves in response to an audio signal 1115 (e.g., from amplifier 445).

In example 1060 a cross-sectional view of a channel (e.g., a single channel, a right channel or a left channel) of hybrid headphone 500 depicts speaker 443 coupled with the mounting plate 1006 and ports 1010 and 1012 positioned in mounting plate 1006. An acoustic chamber 1008 forms an acoustic volume 1050 behind speaker 443. Acoustic chamber 1008 may include a port such as a port 1014 positioned in a structure of the acoustic chamber 1008. In some examples, acoustic chamber 1008 may be operative as an endcap of hybrid headphone 500. Circuitry (e.g., actuation system 481 of FIG. 4) may be coupled 1011, 1013, 1017 with ports 1010, 1012 and 1014, respectively. The circuitry may be operative to open the ports, close the ports, or to actuate the ports to an intermediate position that is partially open or partially closed, for example. Ports 1010, 1012 and 1014 may be implemented using apparatus including but not limited to the ports 490 and/or shutters 480, 620, 720a and 720b, for example. In example 1060, if a separate end cap is used (e.g., positioned behind acoustic chamber 1008), then port 1014 or other ports may extend through the end cap to allow sound and/or air flow (ambient and/or generated by speaker 443) to pass thought the port.

Ports 1012 and 1014 may be actuated to an open position (e.g., partially open or fully open) to attenuate an excess bass response that may be caused by port 1014 being opened (e.g., partially or fully open), by mixing of a front pressure wave P1 generated by speaker 443 (e.g., in a volume 1051 between ear 551,552 and speaker 443) with a back pressure wave P2 generated be speaker 443 (e.g., in acoustic volume 1050).

Hybrid headphone 500 may be a sealed (e.g., closed back headphone when 1010, 1012 and 1014 are all closed. However, one or more of the ports 1010, 1012 or 1014 may be opened (e.g., fully opened or partially opened) to shape a frequency response of the hybrid headphone 500. Example 1090 depicts a sound pressure level (SPL) falloff in decibels (dB) in a low frequency region LF of frequency response curve 1191 when the hybrid headphone 500 is in a closed back configuration (e.g., ports 1010, 1012 and 1014 are closed) as denoted by a dashed line “Closed”. Frequency response curve 1191 may be altered to reduce a low frequency loss in the LF range by opening one or more of the ports (e.g., port 1012 to a partially or fully open position) as denoted by “Open” within the LF range of frequency response curve 1191, where low frequencies are boosted relative to the levels of low frequencies represented by the dashed line for “Closed”. Port 1012 may be opened, closed, or partially opened to shape a frequency response of the hybrid headphone 500, for example. Although port 1012 was used as one example, other ports, such as ports 1010 and/or 1014 may be opened, closed, or partially opened to shape a frequency response of the hybrid headphone 500. Signals that are coupled (1011, 1013, 1017) with ports 1010, 1012 and 1014 may be generated by one or more systems, circuitry, or algorithms included in hybrid headphone 500, including but not limited to processor 410, actuation system 481, audio system 440, I/O system 460, logic circuitry 450, data storage 420, an application (e.g., APP 580) on a client device (e.g., 590) in communication with the hybrid headphone 500, just to name a few. As one example, a DSP coupled with signals from microphones carried by hybrid headphone 500 may analyze signals from the microphones, determine based on operating mode which ports and/or shutters to actuate to a state (e.g., open, partially open or closed) to obtain a desired frequency response, provide privacy (e.g., for phone calls), implement ANC, implement open-back, or closed-back modes. The DSP may modify frequency content in the audio signal 1115 applied to speaker 443 to obtain an overall frequency response that is due in part to the state of the ports and/or shutters and due in part to the DSP modified frequency response.

For example, the frequency response curves depicted in example 1090 may be due in part, to a state of ports 1010, 1012, 1014 (e.g., open, closed, partially open), and may also be due to the signal 1115 applied to speaker 443 include a modified frequency response (e.g., equalization applied to one or more frequencies or frequency ranges by a DSP and/or algorithms) that when combined with the state of ports 1010, 1012, 1014 produces the frequency response curves depicted in example 1090.

Hybrid headphone 500 may be operated in a sealed mode or an open mode as described above. In the sealed mode, all of the ports (e.g., ports and/or shutters) may be closed. Content on a client device (e.g., client device 590 of FIG. 5) may include data representing operating mode settings and/or commands that may be decoded (e.g., from a field in a data packet that includes the content as a data payload) and the decoded data may be operative to cause closing the ports/shutters when the content includes a phone call (e.g., for privacy and/or to reduce ambient noise) or the content includes play back at a loud listening level (e.g., for privacy and/or to not disturb others). In some examples, activation of an ANC mode may be operative to close ports/shutters on hybrid headphone 500. The decoded data may be operative to open ports/shutter, close ports/shutters or cause partial opening of ports/shutters.

One or more transducers (e.g., microphones, accelerometers, motion sensors) may be positioned at one or more locations in hybrid headphone 500 and signals from those one or more transducers may be used for one or more functions including but not limited to ANC, equalization, mixing pressure waves P1 and P2, and actuation of one or more of the ports 1010, 1012 or 1014. Transducer 1031 may be positioned to receive ambient sound (561, 562) and a signal from transducer 1031 may be coupled 1032 with circuitry and/or algorithms for an active noise cancellation (ANC) system. Port 1014 and other ports (e.g., 1010, 1012) may be closed when the ANC mode is activated. Transducer 1033 may be positioned in acoustic chamber 1008 and may be used to sense sound from speaker 443 and/or pressure wave P2. Transducer 1035 may be positioned in volume 1051 and may be used to sense sound from speaker 443 and/or pressure wave P1. Signals from transducers 1033 and 1035 may be coupled 1034 and 1036, respectively, with circuitry and/or algorithms configured to one or more functions including but not limited to mixing pressure waves P1 and P2, actuation of one or more of the ports (1010, 1012, 1014), ANC, equalization, altering frequency response (e.g., as in example 1090), just to name a few. In some examples, one or more of ports (1010, 1012, 1014) may be manually actuated (e.g., by a user) using a button (e.g., on hybrid headphone 500 or headphone cable 545), an icon, GUI, drop down menu or the like on a client device (e.g., client device 590), or a voice command, a gesture or a motion by a user, just to name a few.

Although the foregoing examples have been described in some detail for purposes of clarity of understanding, the above-described conceptual techniques are not limited to the details provided. There are many alternative ways of implementing the above-described conceptual techniques. The disclosed examples are illustrative and not restrictive.

What is claimed is:

1. A hybrid headphone, comprising:
a processor coupled with a data storage system, a radio, an active noise cancellation system, and a power supply; and
an ear cup including
an ear pad,
an audio system including a speaker coupled with an amplifier, and a microphone coupled with the active noise cancellation system,
a variable aperture device electrically coupled with the processor, the processor, the processor configured to receive data representing an operating mode,
the processor configured to command the variable aperture device to an open position when the data representing the operating mode indicates an open-back mode, and
the processor configured to command the variable aperture device to a closed position when the data representing the operating mode indicates a closed-back mode,
an acoustic chamber, and
an end cap,
the variable aperture device positioned between the speaker and the acoustic chamber or between the acoustic chamber and the end cap.

2. The hybrid headphone of claim 1, wherein the variable aperture device comprises a shutter including an iris having blades that are reversibly movable between the open position and the closed position.

3. The hybrid headphone of claim 2, wherein the blades are reversibly movable to an intermediate position between the open position and the closed position.

4. The hybrid headphone of claim 1, wherein the data representing the operating mode is included in data representing content received by the processor.

6. The hybrid headphone of claim 5, wherein the data representing the operating mode and the data representing the content are included in a data packet received by the processor.

7. The hybrid headphone of claim 6, wherein the data representing the content is included in a data payload of the data packet and the data representing the operating mode is included in a field of the data packet.

8. The hybrid headphone of claim 1, wherein the processor is configured to command the variable aperture device to the closed position when the data representing the operating mode indicates an active noise cancellation mode or a privacy mode.

9. The hybrid headphone of claim 1, wherein the variable aperture device comprises a port including a plurality of members made from a variable acoustic impedance material.

10. The hybrid headphone of claim 9, wherein a dimension of the variable acoustic impedance material is configured to increase responsive to a signal applied to the variable acoustic impedance material during the closed-back mode.

11. The hybrid headphone of claim 9, wherein a dimension of the variable acoustic impedance material is configured to decrease responsive to a signal applied to the variable acoustic impedance material during the open-back mode.

12. A method, comprising:
detecting an operating mode;
determining if the operating mode is an open-back mode;
commanding a variable aperture device in an ear cup to an open position when the operating mode is the open-back mode;
determining if the operating mode is a closed-back mode; and
commanding the variable aperture device to a closed position when the operating mode is the closed-back mode.

13. The method of claim 12 and further comprising:
determining if the operating mode is an active noise cancellation mode; and
commanding the variable aperture device to the closed position when the operating mode is the active noise cancellation mode.

14. The method of claim 12 and further comprising:
determining if the operating mode is a semi-open mode; and
commanding the variable aperture device to an intermediate position that is between the open position and the closed position, when the operating mode is the semi-open mode.

15. The method of claim 12 and further comprising:
determining if the operating mode is a privacy mode; and
commanding the variable aperture device to the closed position when the operating mode is the privacy mode.

16. The method of claim 12, wherein the variable aperture device comprises a shutter.

17. The method of claim 12, wherein the variable aperture device comprises a port including a plurality of members made from a variable acoustic impedance material.

18. The method of claim 12 and further comprising:
receiving, at a processor, data representing content configured for playback on a speaker;
extracting, using the processor, data representing an operating mode from the data representing the content;
decoding, using the processor, the data representing the operating mode to generate an operating mode signal from the processor; and
applying the operating mode signal to the variable aperture device to command a position of the variable aperture device.

19. The method of claim 18, wherein the position comprises the open position or the closed position.

20. The method of claim 18, wherein the position comprises an intermediate position that is between the open position and the closed position.
